(19) United States
(12) Patent Application Publication
(10) Pub. No.: US 2007/0162647 A1
(43) Pub. Date: Jul. 12, 2007

(54) System and Method for Performing Scatter/Gather Direct Memory Access Transfers

(75) Inventor: Ivo Tousek, Stockholm (SE)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES, INC., Taipei (TW)

(21) Appl. No.: 11/610,598

(22) Filed: Dec. 14, 2006

Related U.S. Application Data
(63) Continuation-in-part of application No. 11/467,471, filed on Aug. 25, 2006.
(60) Provisional application No. 60/751,718, filed on Dec. 19, 2005.

(51) Int. Cl. G06F 13/28

(52) U.S. Cl. 710/22

(57) ABSTRACT

The present application describes systems and methods for performing direct memory access (DMA) from a source memory to a destination memory. One such method comprises retrieving address values to specify starting locations in the source memory and the destination memory; retrieving a size value to specify a number of units of a data line; retrieving a count value to specify a number of data lines to be transferred from the source memory to a destination memory, in which the data line consists a plurality of consecutive data units; retrieving an offset value to specify a fixed separation spacing between data lines being transferred consecutively; transferring the data lines per line each time from the source memory to the destination memory consecutively according to the source address value, the destination address value, the size value, the count value and the offset value; and terminating the transferring in response to the transferring of all data lines of the DMA transfer.

### CROSS-REFERENCE TO RELATED APPLICATIONS

The present application in a continuation-in-part of U.S. patent application Ser. No. 11/467,471, filed on Aug. 25, 2006, the contents of which are hereby incorporated by reference. The present application also claims the priority benefit of U.S. provisional application Ser. No. 60/751,718, filed on Dec. 27, 2005, entitled “Fixed Offset Scatter/Gather DMA Controller,” the contents of which is hereby incorporated by reference.

### BACKGROUND OF THE INVENTION

Direct memory access (DMA) transfers are well-known. In a DMA transfer, data is transferred directly from one memory device to another memory device, without having to be routed through a processor or other intervening device. By way of example, reference is made to FIG. 1, which is a block diagram illustrating certain components of a computing system, as is well-known in the art. In the illustrated system 10, separate memory devices 12 and 14 are coupled to a system bus 15, a processor 16 is also coupled to the bus 15. Frequently, and for any of a variety of reasons, data contained within one of the memory devices is to be moved to the other memory device.

By way of example, assume an item of data in memory 12 is to be moved to memory 14. One way to affect this transfer is for the processor 16 to perform a read of the data item from memory 12, which results in the data item being transferred from memory 12 into the processor 16. Thereafter, the processor can write that data item to a specified location within memory 14. While this is an acceptable method of moving single data items, or even small amounts of data, often it is desired to move an entire block of data from one memory device to another. DMA transfers greatly streamline this process, by eliminating the need for each data item to be routed through the processor (or other intervening device) as a part of the transfer.

In a DMA transfer, movement of data from a first memory to a second memory is controlled by a DMA controller 20. A processor 16, or other appropriate circuit logic, typically initiates the transfer by configuring the DMA controller 20 with the requisite configuration details. In a simple DMA transfer, these details include a starting address in the source memory 12, a starting address in the destination memory 14, and the amount of data to be transferred. Typically, DMA controllers include control registers 22 that may be configured by the processor 16 with this information. Once configured, the DMA controller 20 thereafter provides the necessary signaling to the memory devices 12 and 14 to control the transfer of data from the source memory 12 to the destination memory 14. As is illustrated by reference numeral 19, once the DMA sequence starts, data is effectively transferred directly from the source memory 12 to the destination memory 14. Of course, the data is transferred across the bus 15, where other data transactions may be transpiring as well. For example, the processor 16 may be reading or writing information to and from other devices coupled to the bus 15. To this end, arbitration logic 18 is commonly provided to sequence and control transfers across a bus 15 so as to avoid bus contentions.

As DMA and bus arbitration operations are well-known and understood, they need not be described herein in any further detail.

In addition to basic DMA operations, in which a single, contiguous block of data is transferred from a source memory to a destination memory, other, more complex, DMA operations are known as well. One such DMA operation is referred to as a “gather” operation. In a gather DMA operation, multiple blocks of data, which exist in separate areas of a source memory are transferred to a contiguous area in a destination memory. Such an operation is illustrated in FIG. 2A, in which data blocks 32, 34, 36, and 38 may be of different sizes and in distinct locations in a source memory 12. When transferred to a destination memory, however, they are collected to a single, contiguous area. As the name implies, they are “gathered” to a contiguous region. Likewise, and as illustrated in FIG. 2B, another DMA operation is referred to as a “scatter” operation. In a scatter type of DMA, a plurality of contiguous data blocks 42, 44, 46, and 48 are transferred into a destination memory 14 into separate and distinct areas of the memory. As the name implies, the data is scattered when written into the destination memory 14. The term “scatter/gather” will be used herein to generically refer to DMA transfers that are either of a scatter type or a gather type.

Although the scatter/gather DMA illustrations in FIGS. 2A and 2B illustrate the scattering of data originally stored in a contiguous region, or the gathering of data into a contiguous region, other scatter/gather DMA operations may move data from noncontiguous locations in a source memory to noncontiguous regions in a destination memory. These types of scatter or gather DMA operations typically require a more complex configuration and operation by the DMA controller. In this regard, typically a mapping table, linked list, or other structure is utilized by the DMA controller 20 in order to properly map the source data blocks to the destination data blocks where they are to be transferred.

Accordingly, it is desired to provide systems and methods for accommodating or performing scatter/gather types of DMA operations more efficiently and economically.

### SUMMARY

To achieve certain objects and advantages, the present application is directed to systems and methods for performing direct memory access (DMA) from a source memory to a destination memory. One such method comprises storing a single first parameter value into a first location to specify a number of consecutive data units to transfer, which consecutive data units make up a line of data. The method further comprises storing a single second parameter value into a second location to specify a fixed separation spacing between lines of data being transferred consecutively. The method also comprises storing a single third parameter value into a third location to specify a number of lines of data to be transferred.

In an embodiment of the present invention, a method for performing direct memory access (DMA) of data lines from a source memory to a destination memory is disclosed. The method comprises: retrieving a source address value to specify a starting location in the source memory; retrieving a destination address value to specify a starting location in the destination memory; retrieving a size value to specify a number of units of a data line; retrieving a count value to specify a number of data lines to be transferred from the source memory to a destination memory, in which the data line consists a plurality of consecutive data units; retrieving an offset value to specify a fixed separation spacing between data lines being transferred consecutively; transferring the data lines per line each time from the source memory to the destination memory consecutively according to the source address value, the destination address value, the size value, the count value and the offset value; and terminating the transferring in response to the transferring of all data lines of the DMA transfer.

In another embodiment of the present invention, a method for performing direct memory access (DMA) of data macroblocks from a source memory to a destination memory is disclosed. The method comprises: retrieving a source address value to specify a starting location in the source memory; retrieving a destination address value to specify a starting location in the destination memory; retrieving a line size value to specify a number of units of a data line, wherein the data line consists of a plurality of consecutive data units; retrieving a line count value to specify a number of data lines of a data macroblock, in which the data macroblock consists of a plurality of lines being transferred consecutively; retrieving a line offset value to specify a fixed separation spacing between data lines consecutively transferred in the data macroblock; retrieving a macroblock count value to specify a number of data macroblocks to be transferred from the source memory to the destination memory; retrieving a macroblock offset value to specify a fixed separation spacing between data macroblocks being transferred consecutively; transferring the data per macroblock each time from the source memory to the destination memory consecutively according to the source address value, the destination address value, the macroblock count value and the macroblock offset value, wherein the data macroblock is transferred per data line each time according to the line count value and the line offset value; and terminating the transferring in response to the transferring of all data macroblocks of the DMA transfer, in which the line size value and the line count value of each data macroblock are equal.

In another embodiment of the present invention, a direct memory access (DMA) controller for performing DMA transfer of lines of data is disclosed. The DMA controller comprises: storage logic to store a plurality of transfer parameters of a data transfer; and control logic to control the data transfer from a source memory to a destination memory according to the plurality of transfer parameters; in which the transfer parameters comprise address values specifying locations of data, a size value specifying a number of units of a data line, a line count value specifying a number of data lines, and a line offset value specifying a fixed separation spacing between data lines to be transferred consecutively, which each data line consists consecutive data units.

In yet another embodiment of the present invention, a direct memory access (DMA) controller for performing DMA transfer of macroblocks of data is disclosed herein. The DMA controller comprises: storage logic to store a plurality of transfer parameters of a data transfer; and control logic to control the data transfer from a source memory to a destination memory according to the transfer parameters. Furthermore, the transfer parameters comprise: address values specifying locations of data in the source memory and the destination memory, a size value specifying a number of units of a data line; a line count value specifying a number of data lines of a data macroblock, a line offset value specifying a fixed separation spacing between data lines transferred consecutively in the data macroblock, a macroblock count value specifying a number of data macroblocks to be transferred, and a macroblock offset specifying a fixed separation spacing between data macroblocks to be transferred consecutively;in which the line size value and the line count value of each data macroblock are equal.

The present application is also directed to other methods of performing scatter/gather DMA transfers and systems for controlling such DMA operations.

### BRIEF DESCRIPTION OF THE DRAWINGS

The accompanying drawings are included to provide a further understanding of the present invention, and are incorporated in and constitute a part of this description. The drawings illustrate embodiments of the present invention, and together with the description, serve to explain the principles of these embodiments. There is shown:

FIG. 1 is a block diagram of a portion of a system illustrating components used for certain conventional DMA operations.

FIG. 2A is a diagram illustrating a gather type DMA operation.

FIG. 2B is a diagram illustrating a scatter type DMA operation.

FIG. 3A illustrates a display area, and a movement of a graphic window within that display area.

FIG. 3B is a diagram illustrating a scatter/gather DMA operation, having a constant and fixed offset or separation distance between segments of data.

FIG. 4 is a flow chart illustrating the top-level operation of a method for performing a scatter/gather operation constructed in accordance with an embodiment of the invention.

FIG. 5 is a block diagram illustrating certain components within a DMA controller constructed in accordance with an embodiment of the present invention.

FIG. 6 is a block diagram illustrating certain components within a DMA controller constructed in accordance with an embodiment of the present invention.

FIG. 7 is a flow chart illustrating the top-level operation of a method for performing a scatter/gather operation constructed in accordance with an embodiment of the invention.

FIG. 8 is a block diagram illustrating certain components within a DMA controller constructed in accordance with an embodiment of the present invention.

FIG. 9 is a block diagram illustrating certain components within a DMA controller constructed in accordance with an embodiment of the present invention.

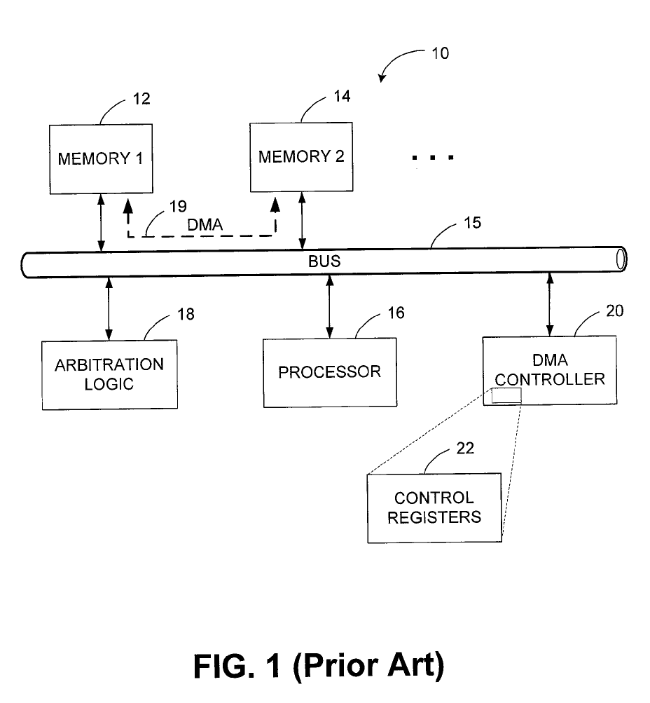

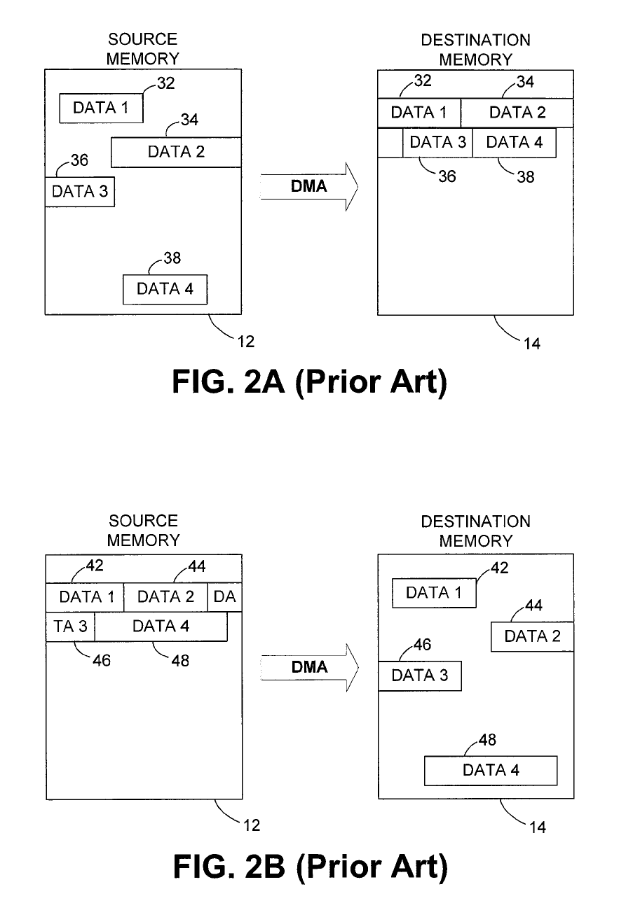

### DETAILED DESCRIPTION

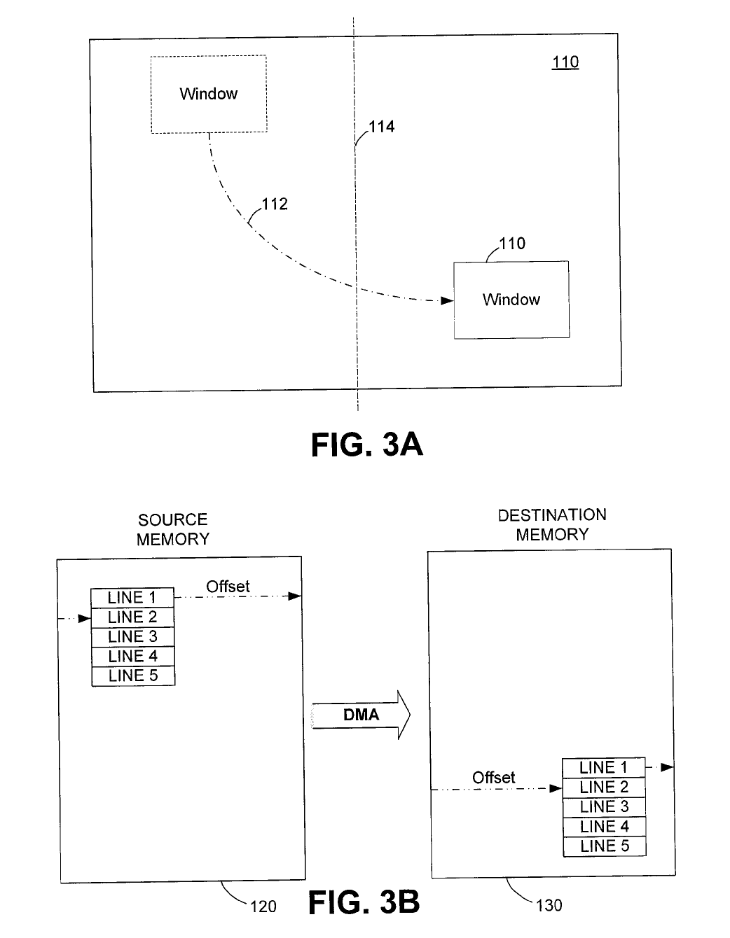

Certain embodiments of the present invention are directed to unique systems and methods for performing scatter/gather types of DMA transfers, wherein the blocks of data are of constant and uniform sizes, and spacing between successive blocks of data are likewise constant. This is referred to herein as a fixed-offset scatter/gather DMA. Before describing specific structural features or operations of embodiments of the present invention, reference is first made to FIGS. 3A and 3B, which provide an illustration of a circumstance in which such a fixed-offset scatter/gather type of DMA would be desired. As illustrated in FIG. 3A, a graphics display 100 may include, among other items, a display of a window 110. In an operation in which a user drags the window 110 from a first location to a second location (illustrated by the dashed line 112), the underlying data for displaying the graphic window 110 may need to be moved within the frame buffer memory. Stated another way, one way in which the window 110 is moved from a first display location to a second display location may be carried out by doing a block transfer of the data from one location in a frame buffer memory to another location within the frame buffer memory. Assume further, for the sake of illustration, that the frame buffer memory consists of two memory devices 120 and 130 (see FIG. 3B), which are arranged to each cover one half of the display area 100. This allocation is illustrated in this example by reference line 114, wherein data defining the half of the display 100 to the left of reference line 114 is stored in memory 120, while data defining the half of the display 100 to the right of reference line 114 is stored in memory 130.

Assuming the arrangement or organization of the data within the memories 120 and 130 generally corresponds to the dimensional layout of the display, the first data item to be moved in the DMA transfer would correspond to the upper left pixel of window 110. Assuming further, for the sake of simplicity, that the window 110 has a vertical dimension of only five pixels, and a horizontal dimension of one hundred pixels. If there is one data unit (e.g., byte, word, double word, etc.) associated with each pixel, then there will be five blocks of data to be transferred from memory 120 to memory 130, with each transfer block being one hundred data units in length. Such blocks are defined by a plurality of contiguous data units, and are also referred to herein as lines of data.

As illustrated in FIG. 3B, after each line of data is transferred, there is an offset of a certain amount before reaching the data value for the first data item in the next (successive) line to be transferred. This offset or separation is the same for each successive line of data. As such, this separation or offset is a fixed value. Likewise, in the destination memory, the offset separating each line of data will similarly be fixed.

The foregoing has presented merely one example of a situation in which a plurality of lines (or blocks) of data are transferred from a source memory to a destination memory, whereby each line of data is separated by a constant and fixed amount. Embodiments of the present invention are provided for applications in which such a fixed-offset scatter/gather type of DMA operation is desired.

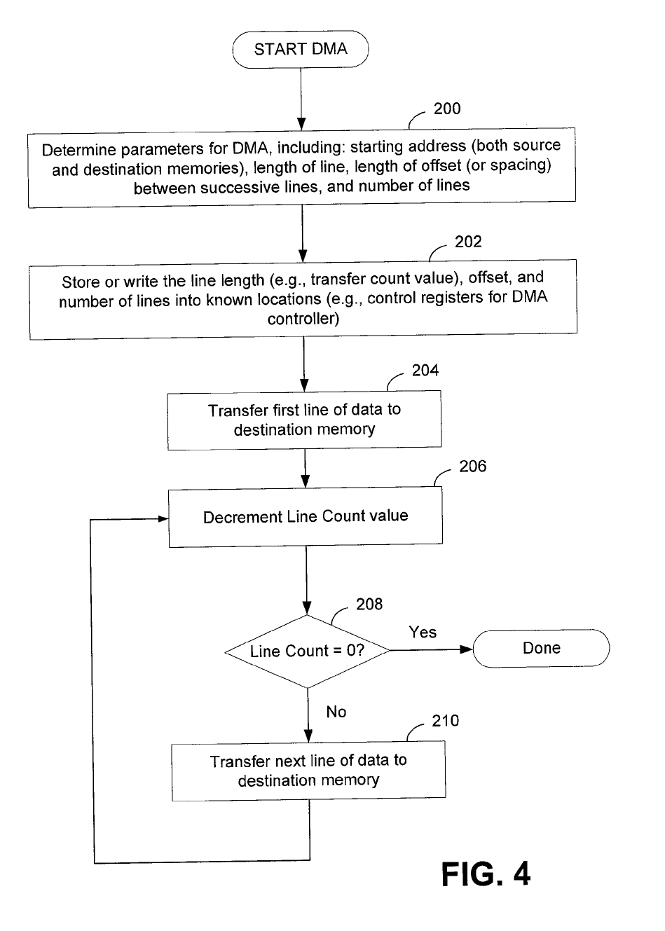

Reference is now made to FIG. 4, which is a flow chart illustrating the top-level operation of a method for performing a DMA operation, in accordance with an embodiment of the present invention. The method begins at step 200, when a DMA transfer is desired, in which a plurality of lines of data are to be transferred from a source memory to a destination memory, with each line of data comprising a fixed size and having a constant and fixed offset between successive lines of data. In step 200, a determination is made for the various parameters that will define the DMA transaction. These parameters include, among others, a starting address in both the source and destination memories, the number of data units (e.g., bytes, words, double words, etc.) in a block or line of data, the length of the offset (or spacing) between successive lines of data, and the total number of lines of data to be transferred. Thereafter, certain of these parameters are stored in known locations for the DMA controller. Specifically, the line length (also referred to as a transfer count), line offset value, and the number of lines to be transferred are stored in known locations, such as dedicated registers, within the DMA controller (step 202). Then, a first line of data is transferred to the destination memory (step 204) and the line count value is decremented (step 206). If the line count value is equal to zero, then all lines have been transferred (step 208). Otherwise, the next line of data is transferred (step 210) and the method returns to step 206. This transfer and decrement process is repeated until the line count value is equal to zero (step 208), which completes the DMA transaction.

In another embodiment of the present invention, these parameters can be retrieved directly from the request making the DMA transfer. In such condition, the DMA controller may obtain these parameters without further determination. Also, these parameters may not necessarily be stored in known locations within the DMA controller. Instead, they are directly used as indices or threshold values for controlling the transfer. For example, these parameters can be retrieved from the request and set to program counters. Then the program counters are used to calculate the amount of lines or units of data being transferred.

In still another embodiment of the present invention, steps 206 and 208 can be implemented in various ways. For example, calculating the amount of the lines of data being transferred or the times that step 204 being executed (a complete transfer of one line of data) to replace step 206. When the amount or the times reaches the line count value, meaning that all the lines of data have been transferred, then the process is terminated to stop transfer (as step 210 does). A counter can be added to calculate the amount of the lines of data being transferred. The counter can be also used to calculate the times that step 204 has been executed, depending on practical design needs. Yet in another variation, the line size can be used to determine a complete transfer of step 204. For example decrement the line size value each time a unit of data is transferred within a line. When the line size value is equal to zero, i.e. a complete line of data has been transferred, the amount of the lines of data being transferred or the times of complete transfer of one line is incremented. In either way of the above embodiments, the DMA transfer can be monitored and controlled by using these transfer parameters.

It should be appreciated that the above-described embodiment of the present invention achieves a relatively complex DMA operation in a very efficient manner, and with significantly reduced complexity, when compared with prior art scatter/gather DMA operations and controllers, which require mapping tables, linked lists, or other complex structures for carrying out the transfer.

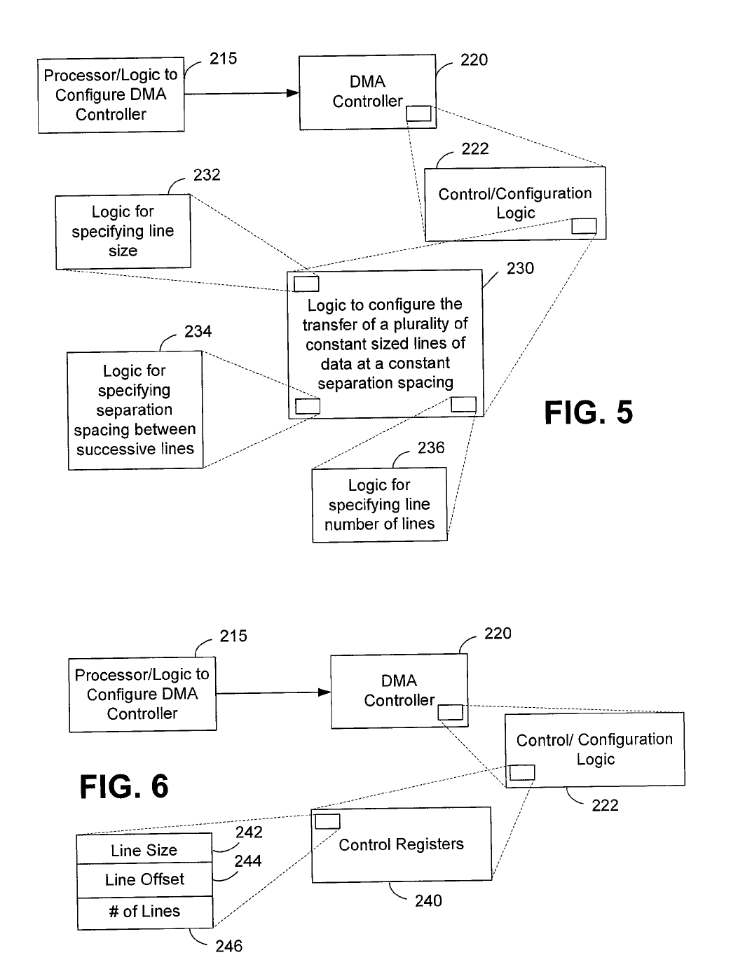

Reference is now made to FIG. 5, which is a block diagram illustrating certain components within a DMA controller 220 constructed in accordance with an embodiment of the present invention. In this embodiment, the DMA controller 220 includes control or configuration logic 222 for controlling signal lines to source and destination memory devices (not shown) to carry out a fixed-offset scatter/gather type DMA operation. A processor 215 or other logic is configured to store configuration information within the DMA controller 220, which configuration information is used to set up the DMA controller 220 to carry out the desired DMA operation. As mentioned above in connection with FIG. 4, such configuration information includes a line length, which is the same for each of a plurality of lines of data to be transferred. The configuration information also includes a line offset, which is fixed for each successive line updated to be transferred. The configuration information further includes a number of lines to be transferred.

Inside the configuration logic 222 is logic 230, which configures the DMA controller 220 for the transfer of a plurality of constant size lines of data, each having a constant or fixed separation spacing. As a part of this logic 230, further logic 232 is provided for specifying the line size, logic 234 for specifying the separation spacing between successive lines, and logic 236 for specifying the number of lines. It should be appreciated that these various logic components may take on a variety of forms or implementations consistent with the scope and spirit of the present invention.

For example, reference is made briefly to FIG. 6, which is a block diagram illustrating a particular embodiment of the present invention. In this illustrated embodiment, the control or configuration logic 222 comprises a plurality of control registers 240, which include a separate register for each of: (1) the value of the line size 242, (2) the value of the line offset 244, and (3) the value for the number of lines to be transferred 246. In the illustrated embodiment, each of these values is stored in a separate register of a larger set of control registers 240. In yet another embodiment (not specifically illustrated), a single control register may be provided to store these three values collectively. In such an embodiment, the separate values may merely comprise certain fields within a control register. Indeed, the manner of implementation of this control information may vary based upon memory sizes to be supported and the expected size of these values (e.g., if the size of these values expected to be three to four bits in length, then it may be implemented as a field of a larger register, whereas if the expected size of these values is to be sixteen to thirty-two bits in length, then separate registers may be provided).

The foregoing has described embodiments of the present invention for performing a fixed-offset scatter/gather DMA, where a single macroblock of data is transferred from a source memory to a destination memory. Other embodiments of the present invention cover systems and methods that transfer multiple such macroblocks from a source memory to a destination memory. For a given macroblock of data to be transferred, each of the plurality of lines of data within a given macroblock are separated by a fixed offset. Likewise, a fixed offset also defines the separation distance between each of the plurality of macroblocks. The offset separating successive lines in a macroblock is independent of the offset defining the separation distance between successive macroblocks.

One application in which such a transfer of data may be desired is in video processing or graphics arts. For example, motion detection and motion estimation are performed using known spiral-search algorithms that operate on macroblocks of defined sizes. Each of the plurality of macroblocks is the same sized as the other macroblocks, and in certain spiral-search algorithms the plurality of macroblocks are separated by a consistent or fixed offset.

Again, for purposes of the embodiments of the present invention, the particular applications in which the embodiments are used are not relevant, and therefore the appended claims are not application specific. Instead, the examples of such applications are provided herein merely to illustrate one or more useful applications for the embodiments of the present invention.

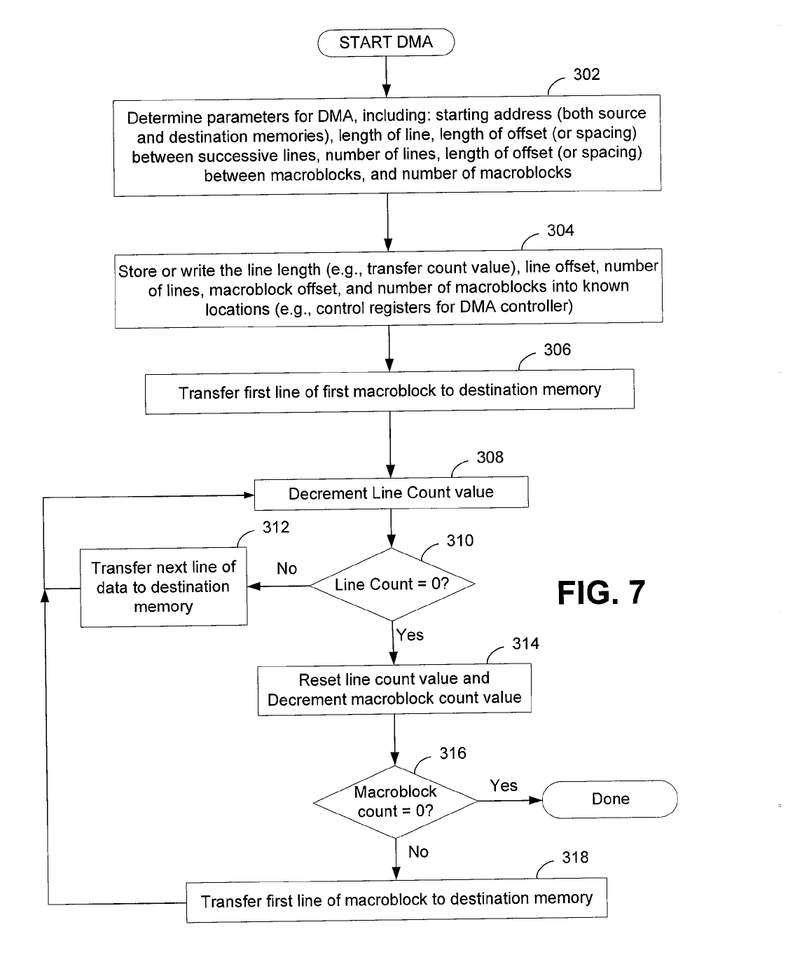

In keeping with the description of the invention, reference is now made to FIG. 7, which is a flow chart illustrating the top-level operation of another embodiment of the present invention. Specifically, in this embodiment, a plurality of macroblocks (each of a fixed size and each having a fixed offset from successive macroblocks) are transferred directly from a source memory to a destination memory. Further, each macroblock is made up of a plurality of lines of data units, with each line of data being a fixed size and having a fixed offset from the successive lines. In beginning the DMA process, a determination is made of parameters that define the DMA operation. These parameters include the starting address of both the source and destination memories (i.e. the starting address of the first data units to be transferred), the length of each data line, the length of the offset or spacing of each data line (e.g., line offset), the number of lines of data in each macroblock, the length of the offset or spacing between macroblocks (e.g., macroblock offset), and the number of macroblocks to be transferred (step 302). Thereafter, certain of these parameters are stored in known locations (step 304). Specifically, the line length, the line offset, the number of lines, the macroblock offset, and the number of macroblocks, are all stored in known locations. In one embodiment, these known locations include control registers within a DMA controller. However, consistent with the scope and spirit of the present invention, these known locations may be outside the DMA controller (so long as they are known by, and accessible to, the DMA controller).

Thereafter, a first line of a first macroblock is transferred from the source memory to the destination memory (step 306). Thereafter, the line count value is decremented (step 308). A determination is made as to whether the line count value has reached a value of zero (step 310). If not, the next or successive line of data is transferred from the source memory to the destination memory (step 312). This decrement and transfer process is continued until the line count value reaches zero. Thereafter, the line count value is reset to its original stored value and the macroblock count value is decremented by one (step 314). Like the check on the line count value of step 310, the macroblock count value is checked to determine whether it has reached a value of zero (step 316). If not, the method proceeds to transfer the first line of the next macroblock to the destination memory (step 318). Thereafter the method returns to step 308 in which the line count value is decremented and the inner loop of the flow chart (steps 308, 310, and 312) are repeated until all of the lines of data of the current macroblock have been transferred to the destination memory. This process is completed once step 316 determines that the macroblock count has reached zero, indicating that all data of all macroblocks have been transferred to the destination memory.

Variations can be made to other embodiments. For example, these parameters can be retrieved directly from the request making the DMA transfer. In such condition, the DMA controller may obtain these parameters without further determination. Also, these parameters may not necessarily be stored in known locations within the DMA controller. Instead, they are directly used as indices or threshold values for controlling the transfer. For example, these parameters can be retrieved from the request and set to program counters. Then the program counters are used to calculate the amount of macroblocks or lines of data being transferred.

As being described above, steps 308, 310, 312, 314 and 316 can be implemented in various ways. Additional counters can be used to calculate the times that the inner loop (step 308,310 and 312) has been executed or the amount of macroblocks of data being transferred. Similarly, other parameters, such as the line length and the line count value, can be used to calculate the transfer of lines of data within a macroblock and the transfer of the macroblocks respectively. By proper calculation, the DMA transfer can be monitored and controlled well. In general, the termination of the DMA transfer is based on whether the macroblocks (or the lines in the embodiment of FIG. 6) of data have been completely transferred fro the source memory to the destination memory. The calculation of the data flow in the DMA transfer can be implemented in different ways but still not departing from the spirit of the present invention.

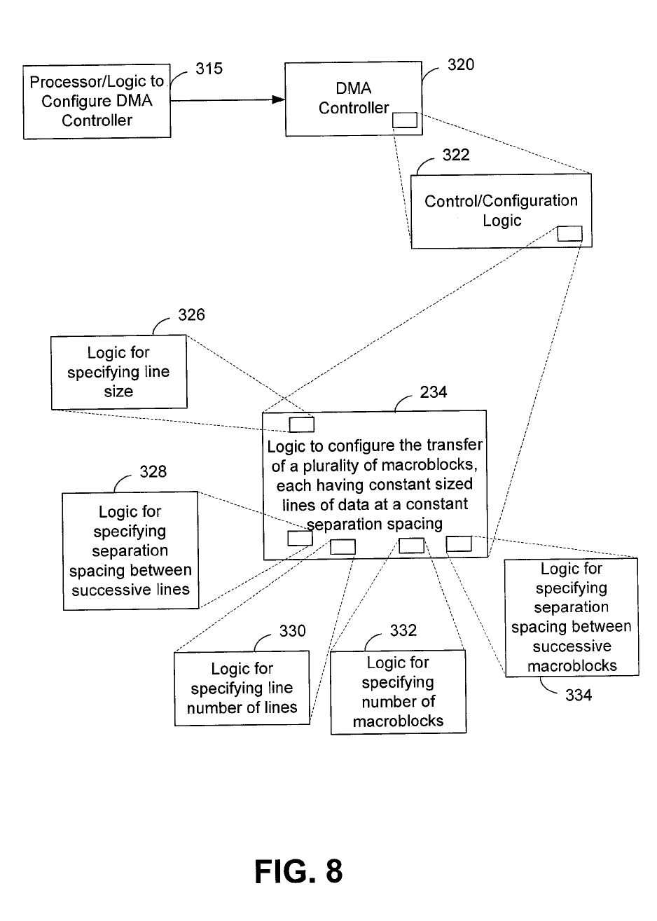

Reference is now made to FIG. 8, which is a block diagram illustrating components of a DMA controller constructed in accordance with an embodiment of the present invention. Specifically, the embodiment illustrated in FIG. 8 is configured to carry out the operations of the embodiment of FIG. 7. Further, the embodiment in FIG. 8 is similar, in many respects, to the embodiment illustrated earlier in FIG. 5.

In this regard, a processor 315 or other appropriate logic can configure a DMA controller 320 (storing certain parameter values within the DMA controller 320 (or in locations outside the DMA controller, but accessible by the DMA controller 320). Configuration logic 322 is provided within the DMA controller to control signal lines to external source and destination memories (not specifically illustrated) to control the desired DMA operation, in which a plurality of macroblocks separated by a fixed offset amount are transferred from a source memory to a destination memory. The control or configuration logic 322 includes logic 324 to configure the DMA transfer of a plurality of constant sized macroblocks, each consisting of a plurality of constant size lines of data and a constant separation spacing. Among other features and components, the logic 324 comprises logic 326 for specifying the line size, logic 328 for specifying the separation spacing (line offset) between successive lines of data, logic 330 for specifying the number of lines in each of the macroblocks, logic 332 for specifying the total number of macroblocks to be transferred, and logic 334 for specifying a separation spacing between successive macroblocks (i.e., macroblock offset). Consistent with the scope and spirit of the present invention, these logic components may be implemented in a variety of forms.

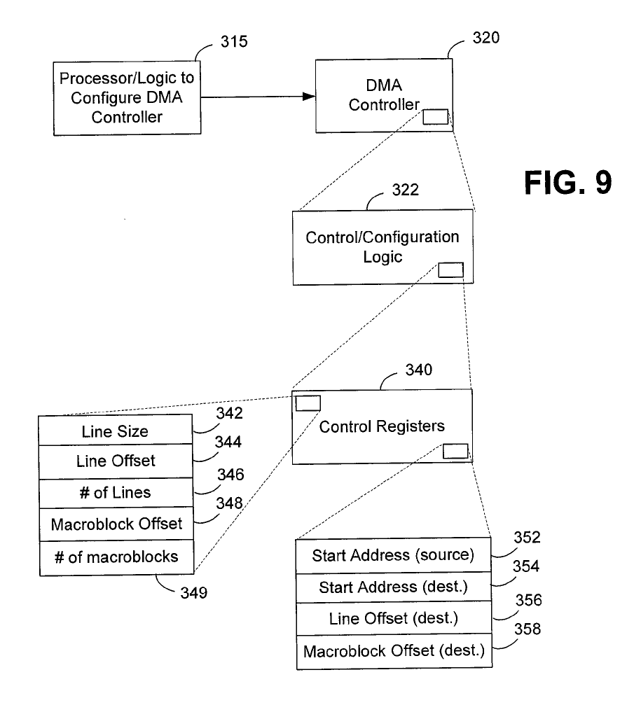

Reference is made to FIG. 9, which illustrates an alternative embodiment of the present invention. In the embodiment of FIG. 9, the configuration functions of various logic elements 326, 328, 330, 332, and 334 of FIG. 8 are embodied in specified control registers 340 of the DMA controller of 320. That is, a separate control register 342 is provided to store a line size value, a separate control register 344 stores a line offset value, a control register 346 stores the value of the number of lines to be transferred, and control register 348 stores a macroblock offset value, and a control register 349 stores a value of the number of macroblocks to be transferred.

Of course, additional control registers and logic will necessarily be provided within the DMA controller 320. However, for purposes of simplicity and more effectively illustrating certain novel aspects of the embodiments of the present invention, the components illustrated in the drawings herein have generally been limited to features that are either: (1) unique to the embodiments of the present invention, or (2) supportive of the illustration of those unique features. As an example, additional control registers within the DMA controller 320 may include a control register for storing the starting address of the first unit of data to be transferred from the source memory 352. Additional control registers may also include a control register 354 for storing a staring address for the first unit of data transferred in the destination memory. Additional control registers may include a control register 356 for storing a line-offset value for the destination memory, and a control register 358 for storing a macroblock-offset value for the destination memory. Additional control registers may also be provided.

In the embodiments previously described, only a single line-offset value was described. That is, the previous embodiments did not describe a separate line-offset value for the source memory and a distinct line-offset value for the destination memory. If only one line offset value is defined, for a gather DMA operation it is assumed that the offset value will be zero in the destination memory. Likewise, for a scatter DMA operation, it will be assumed that the offset value in the source memory is zero (unless a separate offset value for the source memory is defined). However, consistent with the embodiments described herein, separate source and destination line offset values may be specified, such that the offset value of the source memory is different than the offset value of the destination memory, and both values are non-zero. The same is true for macroblock offset values, for the embodiments described herein that support the transfer of a plurality of macroblocks.

In accordance with the foregoing description, it will be appreciated that embodiments of the present invention embody a variety of alternative features and implementations. For example, one embodiment implements a method for performing direct memory access (DMA) from a source memory to a destination memory. One such method broadly operates to: (1) store a single first parameter value into a first location to specify a number of consecutive data units to transfer (e.g., line_size or transfer_count), which consecutive data units make up a line of data, (2) store a single second parameter value into a second location to specify a fixed separation spacing between lines of data being transferred successively (e.g., line_offset), and store a single third parameter value into a third location to specify a number of lines of data to be transferred (e.g., line_count). After this (and perhaps additional) information is stored, embodiments of the invention may transfer the number of lines of data from the source memory to the destination memory.

In embodiments capable of performing either scatter-type or gather-type DMA operations, a method may further comprise storing a scatter/gather indicator (e.g., a flag that, when set indicates a scatter-type DMA and when clear indicates a gather-type DMA). When the scatter/gather indicator indicates a scatter-type DMA operation, the second parameter value indicates a separation spacing between the lines of data in the destination memory, after the DMA transfer. Likewise, when the scatter/gather indicator indicates a gather-type DMA operation, the second parameter value indicates a separation spacing between the lines of data in the source memory, before the DMA.

In one embodiment, each consecutive line of data is separated in the source memory by a fixed amount equal to the second parameter value, and wherein each consecutive line of data is transferred to the destination memory and separated in the destination memory by a fixed amount equal to the second parameter value. In another embodiment, each consecutive line of data is separated in the source memory by a fixed amount equal to the second parameter value, and each consecutive line of data is transferred to the destination memory with no separation between consecutive lines of data (e.g., a gather-type transfer). In yet another embodiment, there is no separation between each consecutive line of data in the source memory, and each consecutive line of data is transferred to the destination memory and separated in the destination memory by a fixed amount equal to the second parameter value (e.g., a scatter-type transfer).

In one embodiment, the parameter value stored in the third location (e.g., line_count) may be decremented each time another line of data is transferred. In such a transfer, the DMA operation ends in association with the parameter value stored in the third location becoming zero.

Of course, consistent with the scope and spirit of the present invention, additional parameters could be stored to specified locations. In this regard, in one embodiment, a method may store a single fourth parameter value into a fourth location to specify a fixed separation spacing between macroblocks of data to be transferred consecutively (e.g., macroblock_offset), wherein each macroblock consists of a plurality of consecutive lines of data, the number of consecutive lines specified by the third parameter value. The method may further store a single fifth parameter value into a fifth location to specify the number of macroblocks of data to be transferred (e.g., macroblock_count).

In yet another embodiment, which supports a DMA operation that transfer noncontiguous lines of data from a source memory to noncontiguous locations in a destination memory, the method may further comprise storing a single sixth parameter value into a sixth location to specify a separation spacing in the destination memory between lines of data that are transferred, wherein the second parameter value specifies a separation spacing in the source memory.

Other operations that may be utilized in connection with the DMA operation may include storing a source_address value into a source_address location to specify a starting location for a first data item in the source memory for data to be transferred, and storing a destination_address value into a destination_address location to specify a starting location for a first data item in the destination memory for transferred data.

In accordance with another embodiment of the invention, a novel DMA controller is provided, which comprises logic for controlling the transfer of a plurality of units of data, which collectively comprise a line of data, with the number of data units being specified by a first parameter value, and logic for controlling the transfer of a plurality lines of data, wherein each of the plurality of successive lines of data being separated by a constant spacing equal to a second parameter value, and a total number of lines of data are specified by a third parameter value. In one embodiment, the logic for controlling the transfer of a plurality of data units comprises at least one control register configured to contain a value that specifies the number of units of data that collectively comprise a line of data.

In another embodiment, the DMA controller according to claim may further comprise a plurality of control registers, wherein the control registers store parameter values that are utilized by the logic for controlling the transfer of a plurality of units of data and the logic for controlling the transfer of a plurality lines of data. Specifically, the plurality of control registers comprise at least three control registers from the following list of nine possible control registers: (1) a control register configured to store a parameter value that specifies the number of data units contained in each line of data, (2) a control register configured to store a parameter value that specifies an offset spacing between each successive line of data in a source memory, (3) a control register configured to store a parameter value that specifies the number of lines of data to be transferred, (4) a control register configured to store a parameter value that specifies a starting address in the source memory, (5) a control register configured to store a parameter value that specifies a starting address in a destination memory, (6) a control register configured to store a parameter value that specifies an offset spacing between successive macroblocks of data, (7) a control register configured to store a parameter value that specifies the number of macroblocks of data to be transferred, (8) a control register configured to store a parameter value that specifies an offset spacing between successive lines of data in a destination memory, and (9) a control register configured to store a parameter value that specifies an offset spacing between successive macroblocks of data in the destination memory. Depending upon the embodiment, more that three of the above control registers may be implemented, and indeed all nine may be implemented.

In yet another embodiment, a DMA controller comprises logic for controlling the transfer of a plurality of macroblocks of data, wherein each of the plurality of successive macroblocks of data is separated by a constant spacing equal to a fourth parameter value (e.g., macroblock_offset), and a total number of macroblocks are specified by a fifth parameter value.

Still other embodiments will be appreciated from the description provided herein. Consistent among the various embodiments is the simplicity and efficiency in which relatively complex DMA operations can be performed, when lines of data are separated (in either a source memory or destination memory) by a constant and fixed amount. Similarly complex DMA operations can be performed on a plurality of similarly-sized macroblocks, when each of the macroblocks is separated from a successive macroblock by a constant and fixed amount.

What is claimed is:

1. A method for performing direct memory access (DMA) of data lines from a source memory to a destination memory, comprising:
retrieving a source address value to specify a starting location in the source memory;
retrieving a destination address value to specify a starting location in the destination memory;
retrieving a size value to specify a number of units of a data line;
retrieving a count value to specify a number of data lines to be transferred from the source memory to a destination memory, wherein the data line consists a plurality of consecutive data units;
retrieving an offset value to specify a fixed separation spacing between data lines being transferred consecutively;
transferring the data lines per line each time from the source memory to the destination memory consecutively according to the source address value, the destination address value, the size value, the count value and the offset value; and
terminating the transferring in response to the transferring of all data lines of the DMA transfer.

2. The method according to claim 1, further comprising:
retrieving an indicator to indicate operation type of the transferring, wherein the operation type is chosen from the followings: a normal operation, a scatter operation and a gather operation.

3. The method according to claim 2, wherein the offset value specifies a fixed separation spacing between data lines in the source memory, and the fixed separation spacing between data lines in the destination memory is zero in the gather operation indicated by the indicator.

4. The method according to claim 2, wherein the offset value specifies a fixed separation spacing between data lines in the destination memory, and the fixed separation spacing between data lines in the source memory is zero in the scatter operation indicated by the indicator.

5. The method according to claim 1, further comprising:
storing the retrieved parameters in dedicated registers respectively.

6. The method according to claim 1, wherein the terminating further comprises decrementing the count value in response to the transferring of each data line until the count value is zero.

7. A method for performing direct memory access (DMA) of data macroblocks from a source memory to a destination memory, comprising:
retrieving a source address value to specify a starting location in the source memory;
retrieving a destination address value to specify a starting location in the destination memory;
retrieving a line size value to specify a number of units of a data line, wherein the data line consists of a plurality of consecutive data units;
retrieving a line count value to specify a number of data lines of a data macroblock, wherein the data macroblock consists of a plurality of lines being transferred consecutively;
retrieving a line offset value to specify a fixed separation spacing between data lines consecutively transferred in the data macroblock;
retrieving a macroblock count value to specify a number of data macroblocks to be transferred from the source memory to the destination memory;
retrieving a macroblock offset value to specify a fixed separation spacing between data macroblocks being transferred consecutively;
transferring the data per macroblock each time from the source memory to the destination memory consecutively according to the source address value, the destination address value, the macroblock count value and the macroblock offset value, wherein the data macroblock is transferred per data line each time according to the line count value and the line offset value; and
terminating the transferring in response to the transferring of all data macroblocks of the DMA transfer;
wherein the line size value and the line count value of each data macroblock are equal.

8. The method according to claim 7, further comprising automatically resetting the line count value to its initially retrieved value in response to the transferring of each complete data macroblock.

9. The method according to claim 7, further comprising retrieving an indicator to indicate operation type of the transferring chosen from the following: a normal operation, a scatter operation, and a gather operation.

10. The method according to claim 9, wherein the macroblock offset value specifies a fixed separation spacing between data macroblocks being transferred consecutively in the source memory, and the fixed separation spacing between data macroblocks being transferred consecutively in the destination memory is zero in the gather operation indicated by the indicator.

11. The method according to claim 9, wherein the macroblock offset value specifies a fixed separation spacing between data macroblocks being transferred consecutively in the destination memory, and the fixed separation spacing between data macroblocks being transferred consecutively in the source memory is zero in the scatter operation indicated by the indicator.

12. The method according to claim 9, wherein the terminating further comprises decrementing the macroblock count value in response to the transferring of each complete data macroblock until the macroblock count is zero.

13. The method according to claim 9, further comprising storing the retrieved parameters in dedicated registers respectively.

14. A direct memory access (DMA) controller, comprising:
storage logic to store a plurality of transfer parameters of a data transfer; and
control logic to control the data transfer from a source memory to a destination memory according to the plurality of transfer parameters;
wherein the transfer parameters comprise address values specifying locations of data, a size value specifying a number of units of a data line, a line count value specifying a number of data lines, and a line offset value specifying a fixed separation spacing between data lines to be transferred consecutively, which each data line consists consecutive data units.

15. The DMA controller according to claim 14, wherein the storage logic comprises:
an address register for storing the address values;
a size register for storing the size value;
a line count register for storing the line count value; and
an line offset register for storing the line offset value;
wherein the address values comprise a source address value specifying a start location of the data transfer in the source memory and a destination address value specifying a starting location of the data transfer in the destination memory.

16. The DMA controller according to claim 15, wherein the control logic comprises:
an address control logic configured to locate data in the source memory and the destination memory according to the source address value and the destination address value respectively;
a line count control logic configured to terminate the data transfer in response to numbers of data lines being transferred reach the line count value; and
a line offset control logic configured to access data line by line in the source memory and the destination memory according to the line offset value.

17. The DMA controller according to claim 16, wherein the transfer parameters further comprise:
an indicator for specifying an operation type;
wherein the operation mode is chosen from the followings: a normal operation, a scatter operation, and a gather operation.

18. The DMA controller according to claim 17, wherein the line offset control logic retrieves data lines consecutively from the source memory according to the line offset value in the gather operation indicated by the indicator.

19. The DMA controller according to claim 17, wherein the offset control logic places data lines consecutively to the destination memory according to the line offset value in the scatter operation indicated by the indicator.

20. A direct memory access (DMA) controller, comprising:
storage logic to store a plurality of transfer parameters of a data transfer;
control logic to control the data transfer from a source memory to a destination memory according to the transfer parameters; and
wherein the transfer parameters comprise:
address values specifying locations of data in the source memory and the destination memory,
a size value specifying a number of units of a data line;
a line count value specifying a number of data lines of a data macroblock,
a line offset value specifying a fixed separation spacing between data lines transferred consecutively in the data macroblock,
a macroblock count value specifying a number of data macroblocks to be transferred, and
a macroblock offset specifying a fixed separation spacing between data macroblocks to be transferred consecutively;
wherein the line size value and the line count value of each data macroblock are equal.

21. The DMA controller according to claim 20, wherein the storage logic comprises:
an address register for storing the address values;
a size register for storing the size value;
a line count register for storing the line count value;
an line offset register for storing the line offset value;
a macroblock count register for storing the macroblock count value; and
a macroblock offset register for storing the macroblock offset value;
wherein the address values comprise a source address value specifying a start location in the source memory and a destination address value specifying a starting location in the destination memory.

22. The DMA controller according to claim 21, wherein the control logic comprises:
an address control logic configured to locate data in the source memory and the destination memory according to the source address value and the destination address value respectively;
a line count control logic configured to reset the data transfer of each data macroblock in response to numbers of data lines being transferred per data macroblock reach the line count value;
a line offset control logic configured to access each data macroblock line by line in the source memory and the destination memory according to the line offset value;
a macroblock count control logic configured to terminate the data transfer in response to numbers of data macroblocks being transferred reach the macroblock count value; and
a macroblock offset control logic configured to access consecutive data macroblocks in the source memory and the destination memory according to the macroblock offset value.

23. The DMA controller according to claim 22, wherein the transfer parameters further comprise:
an indicator for specifying an operation type;
wherein the operation mode is chosen from the followings: a normal operation, a scatter operation, and a gather operation.

24. The DMA controller according to claim 23, wherein the macroblock offset control logic retrieves each data macroblock from the source memory according to the macroblock offset value, and places each data macroblock to the destination memory with zero offset value in the gather operation indicated by the indicator.

25. The DMA controller according to claim 23, wherein the macroblock offset control logic retrieves each data macroblock from the source memory with zero offset value, and places each data macroblock to the destination memory according to the macroblock offset value in the scatter operation indicated by the indicator.
